(19) United States
(12) Patent Application Publication
(10) Pub. No.: US 2020/0311079 A1
(43) Pub. Date: Oct. 1, 2020

(54) WORKLOAD ISOLATION IN A HYBRID DATABASE SYSTEM

(71) Applicant: INTERNATIONAL BUSINESS MACHINES CORPORATION, Armonk, NY (US)

(72) Inventors: Shantan Kethireddy, Chicago, IL (US); Ruiping Li, San Jose, CA (US); Nogi Simanjuntak, San Jose, CA (US); Ying Zeng, San Jose, CA (US)

(21) Appl. No.: 16/369,035

(22) Filed: Mar. 29, 2019

(51) Int. Cl. G06F 16/2453

(52) U.S. Cl. CPC G06F 16/24542

(57) ABSTRACT

A method, system and computer program product for providing workload isolation in a hybrid database system, by: performing a workload in a separate workload isolation system of the hybrid database system, wherein the separate workload isolation system manages data copied from one or more source systems of the hybrid database system and stored on one or more data hubs managed by the separate workload isolation system, and the workload enters the source systems and is re-routed from the source systems to the separate workload isolation system in order to isolate the source systems from the workload being performed by the separate workload isolation system using the data hubs.

### BACKGROUND

The present invention relates generally to workload isolation in a hybrid database system.

There is a need for controlling, isolating, and minimizing the impact of workloads in production relational database management system (RDBMS) environments, to control costs and to maintain service level agreements (SLAs), as well as to maintain responsiveness of the production RDBMS environments.

The present invention satisfies this need.

### SUMMARY

The invention provided herein has many embodiments useful, for example, in implementing a method, system and computer program product for providing workload isolation in a hybrid database system, by: performing a workload in a separate workload isolation system of the hybrid database system, wherein the separate workload isolation system manages data copied from one or more source systems of the hybrid database system and stored on one or more data hubs managed by the separate workload isolation system, and the workload enters the source systems and is re-routed from the source systems to the separate workload isolation system in order to isolate the source systems from the workload being performed by the separate workload isolation system using the data hubs.

### BRIEF DESCRIPTION OF THE DRAWINGS

Referring now to the drawings in which like reference numbers represent corresponding parts throughout:

FIG. 1 illustrates a data sharing isolation configuration, according to one embodiment.

FIG. 2 illustrates a federal isolation configuration, according to one embodiment.

FIG. 3 illustrates a hybrid isolation configuration, according to one embodiment.

FIG. 4 illustrates an automated isolation advisor, according to one embodiment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized, and structural and functional changes may be made without departing from the scope of the present invention.

Overview

The present invention provides workload isolation in a hybrid database system comprised of one or more source systems, such as transactional systems, and a separate workload isolation system that manages one or more data hubs. Data from the source systems is copied to the data hubs, and workloads are re-routed from the source systems to the separate workload isolation system, in order to isolate the source systems from the workload being performed by the separate workload isolation system using the data hubs. The workloads typically comprise one or more queries and the separate workload isolation system returns result sets from the workloads to the source systems. The workloads may also comprise an initial load of the data from the source systems to the data hubs, as well as a refresh of the data from the source systems to the data hubs.

The rationale for the hybrid database system is that transactional systems can be mission-critical to many entities. As a result, these entities tend to be sensitive to any changes that may lead to increased utilization in these transactional systems, as increased utilization directly increases costs and reduces overall system responsiveness. On the other hand, because these transactional systems contain the most important enterprise data, value can be derived from in-place low-latency analysis of the data.

In order to perform this analysis without impacting the transactional systems, data hubs may be used, wherein a data hub is a separate collection of data from one or more source systems, such as the transactional systems. Data is copied from the source systems to these data hubs, and analytic workloads are re-routed from the source systems to be performed using the data hubs.

Some of these data hubs are completely separate from the source systems with separate connection parameters and separate user authentication servers and/or credentials. Other solutions tightly integrate the source systems with the data hubs in a way that the source systems comprise a single point of access, such that security, query optimization, and query re-route is performed by the source systems, and the workload is seamlessly re-routed to the data hubs with the results being returned to the source systems.

An example of such an integrated solution is an IBM DB2 for z/OS™ source system (which is a transactional system) coupled with an IBM DB2 Analytics Accelerator™ (which is a data hub). In this example, data is copied from the source systems into the data hubs, wherein data from each of the source systems is logically separated (by connection and/or user access) in the data hubs. The source systems are the access point to execute queries, so that, when a workload comprising one or more queries enters the source systems, an optimizer in those source systems can choose to re-route the workload to the data hubs. This provides a form of workload isolation in that various parameters can be used to control the re-route of resource-intensive workloads to the data hubs. These parameters allow the end-user to control some of the impact of workloads in the source systems.

However, the above example remains limited in that it does not provide for fuller workload isolation from the source systems, especially for mission-critical transactional systems. There is still impact to the source systems due to:
An initial load of data from the source systems to the data hubs;
A refresh of the data (bulk or continuous replication) from the source systems to the data hubs;
Query optimization;
Query routing; and
Return of result sets from the data hubs to the source systems.

In this invention, workloads including data loading, data refresh or replication, and query execution, are re-routed to a separate “workload isolation” system (e.g. a separate DB2 z/OS™ system) that can be used to:
Load data from the source systems into the data hubs;
Refresh or replicate the data from the source systems to the data hubs;
Handle security checking for the end-user attempting to access the data hubs;
Perform workloads comprising queries received from the source systems using the data hubs;
Gather the result sets from the workloads;
Perform any error handling for the workloads; and
Return the result sets from the workloads to the end-user at the workload isolation system.

An automated isolation advisor manages how the source systems interact with the separate workload isolation system, and determines the value of creating and/or using the separate workload isolation system (in terms of cost savings, capacity savings, etc.). In this regard, the automated isolation advisor creates (manually or dynamically) the separate workload isolation system, identifies the data to be stored on the data hubs, and identifies the workloads for re-routing to the separate workload isolation system.

For example, the automated isolation advisor provides options that allow an administrator to bias how an incoming workload is performed, either by the source systems or re-routed to the separate workload isolation system. Specifically, the automated isolation advisor helps the administrator determine which workloads are candidates for re-routing to the separate workload isolation system, what tables must be loaded into the data hubs by the separate workload isolation system, which tables should be refreshed or replicated from the source systems to the data hubs, as well as collecting and/or generating statistics identifying the potential cost savings of creating the separate workload isolation system (such as any reduction in source systems' utilization vs. the cost of the separate workload isolation system), any overhead or costs associated with performing workloads in the separate workload isolation system vs. in-place in the source systems, etc.

### TECHNICAL DESCRIPTION

The present invention describes three different approaches for the separate workload isolation system, including a data sharing isolation configuration, a federated isolation configuration, and a hybrid isolation configuration.

Data Sharing Isolation Configuration

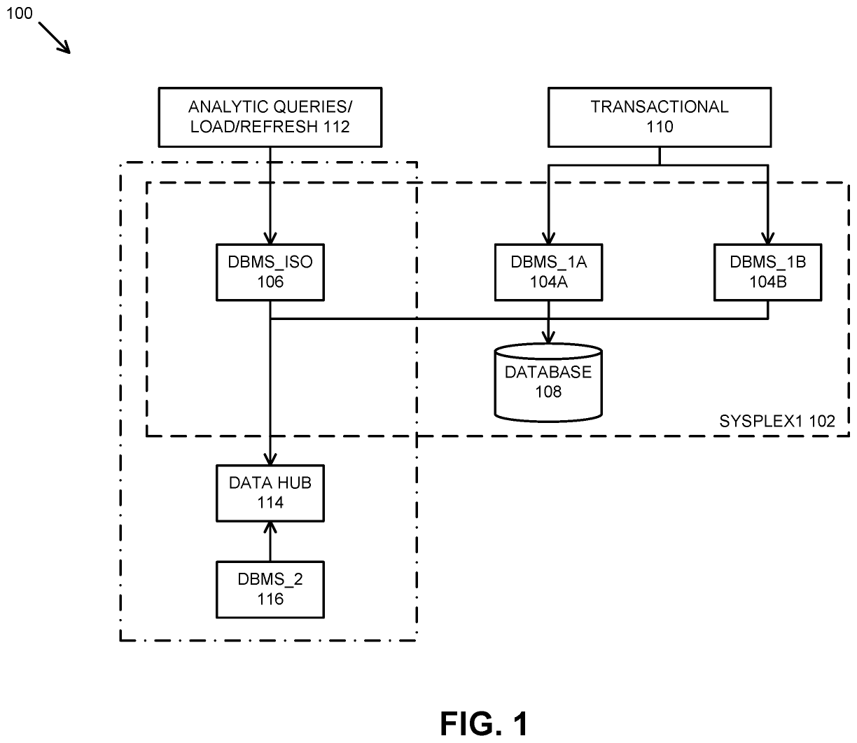

FIG. 1 illustrates a data sharing isolation configuration 100, according to one embodiment. In this embodiment, a systems complex 102 (also labeled as Sysplex1), which is a cluster of computer systems acting as a single image, is comprised of a plurality of source systems 104A, 104B (also labeled as DBMS_1A and DBMS_1B, respectively) and a separate workload isolation system 106 (also labeled as DBMS_ISO), all of which access a shared database 108.

In this embodiment, the source systems 104A, 104B and the separate workload isolation system 106 are subsystems in a share-everything systems complex 102. Typically, in such a systems complex 102, all workloads 110, 112, regardless of whether they are transactional, analytic queries, data loading operations, data refreshing operations, etc., can be performed by any of the subsystems.

In some scenarios, however, it is desirable to isolate a transactional workload 110 as much as possible from other non-transactional workloads 112, and to prioritize the transactional workload 110, since the transactional workload 110 typically comprises a mission-critical workload. This embodiment dedicates one or more of the subsystems, namely, the separate workload isolation system 106, to performing non-transactional workloads 112.

As a result, the source systems 104A, 104B process a transactional workload 110, while the separate workload isolation system 106 processes a workload 112 comprised of analytic queries, data load operations, data refresh operations, etc. Specifically, the separate workload isolation system 106 copies data from the shared database 110 to a data hub 114 provided by another DBMS 116 (also labeled as DBMS_2) in order to perform the non-transactional workload 112. Consequently, the impact of the workload 112 comprising analytic queries on the shared database 108 is lessened to the degree possible.

Specifically, in this embodiment, isolation is provided through the data sharing members, namely, the source systems 104A, 104B and the separate workload isolation system 106:
The shared database 108 is shared across the data sharing members comprising the source systems 104A, 104B and the separate workload isolation system 106.
Only one data sharing member comprised of the separate workload isolation system 106 is connected to the data hub 114.
The separate workload isolation system 106 is only used for the workload 112 comprised of analytic queries, data loading operations, data refreshing operations, etc., that are performed only against the data hub 114. The other data sharing members, namely the source systems 104A, 104B, are used for the transaction workload 110, and are not influenced by the queries and operations performed by the separate workload isolation system 106.

Given that the resources of the shared database 108 (e.g., data, catalog, etc.) are shared across the different data sharing members comprising the source systems 104A, 104B and the separate workload isolation system 106, the workload 112 still has the potential to impact on the source systems 104A, 104B, for example, due to accessing the resources of the shared database 108 when performing the data loading operations and data refreshing operations, etc.

A database administrator (DBA) also can direct the workload 112 comprising the data loading or data refreshing operations from the shared database 108 in the systems complex 102 to the data hub 114. However, the workload 112 comprising the data loading or data refreshing operations from the shared database 108 still has some impact on the shared database 108, as it updates the data hub 114.

Using this workload isolation through the separate workload isolation system 106, the transactional workload 110, such as insert, update, delete and query operations, are performed by the source systems 104, 104B. The transactional workload 110 thus is not impacted by the workload 112 performed by or for the separate workload isolation system 106 and/or the data hub 114.

The subsystem comprised of the separate workload isolation system 106 also can be configured to have a smaller configuration, with other subsystems comprised of the source systems 104A, 104B having a larger configuration and dedicated to time-sensitive and/or mission-critical transactional workloads 110.

This embodiment also includes an automated isolation advisor described below that assists a database administrator in identifying usage patterns in the system complex 102, in order to advise and help in creating the separate workload isolation system 106, and re-routing workloads 112 to the separate workload isolation system 106.

Federal Isolation Configuration

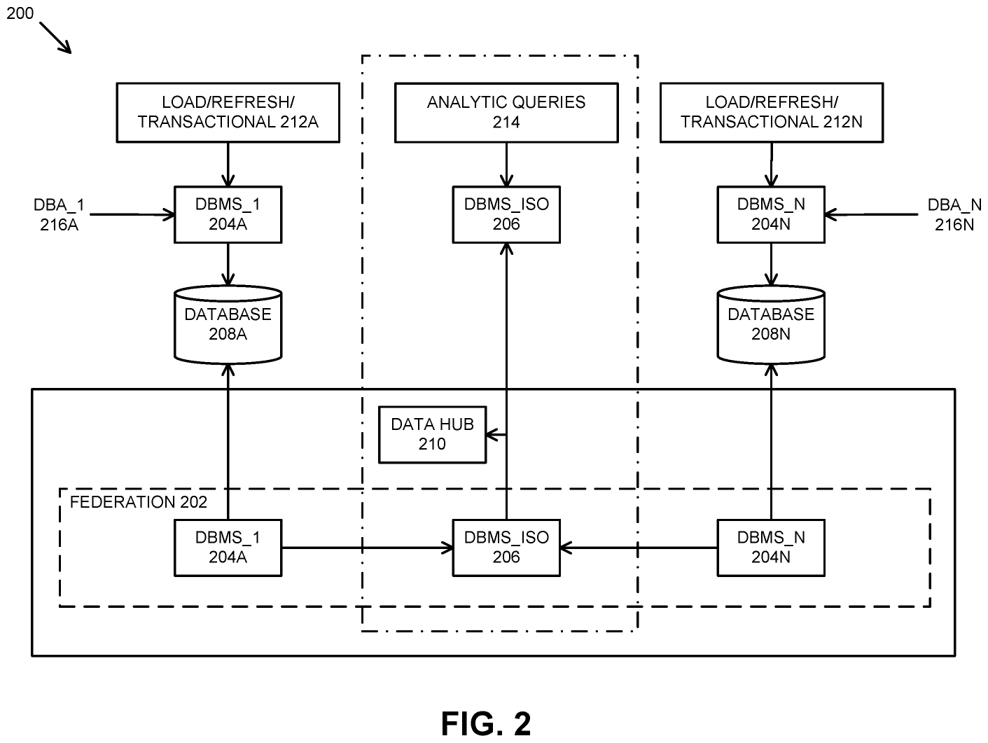

FIG. 2 illustrates a federal isolation configuration 200, according to one embodiment. In this embodiment, a federation 202, which is a distributed system comprised of plurality of source systems 204A-204N (also labeled as DBMS_1 through DBMS_N, respectively) and a separate workload isolation system 206 (also labeled as DBMS_ISO), wherein the source systems 204A, 204N each manage one or more separate databases 208A, 208N of a federated database, and the separate workload isolation system 206 can access any database 208A, 208N of the federated database.

This embodiment describes a workload isolation based on federation 202 in the data hub 210. The source systems 204A, 204N are separate systems, wherein each may be a single subsystem or be comprised of multiple subsystems. Each of the source systems 204A, 204N connects to the same data hub 210 and each directs their analytic queries 214 to the data hub 210.

The source systems 204A, 204N process a workload 212A, 212N comprised of data loading, data refreshing and/or transactional operations, while the separate workload isolation system 206 processes a workload 214 comprised of analytic queries, etc. In addition, the separate workload isolation system 206 accesses the databases 208A, 208N via a data hub 210 provided by the federation 202.

If the workload 214 comprising analytic queries and the workload 212A, 212N comprising data loading, data refreshing, and transactional operations were performed on the same source systems 204A, 204N, they would impact each other, for example, with regard to catalog locks, statement caches, etc.

This embodiment allocates the separate workload isolation system 206 connected to the data hub 210 that only handles the workload 214 comprising analytic queries. The source systems 204A, 204N can federate their databases 208A, 208N in the data hub 210, so that the separate workload isolation system 206 can have read-only access to the databases 208A, 208N of the source systems 204A, 204N through the data hub 210.

Specifically, in this embodiment, isolation is provided through the separate workload isolation system 206 with federation 202:
The data can be federated from the different databases 208A, 208N of the source systems 204A, 204N to the data hub 210.
The separate workload isolation system 206 is connected to the data hub 210.
For each table in the different databases 208A, 208N of the source systems 204A, 204N, a corresponding remote alias is defined in the separate workload isolation system 206 that links to the table.
The separate workload isolation system 206 is only used for the analytics workload 214; the source systems 204A, 204N that perform data loading, data refreshing, and transactional workloads 212A, 212N are totally isolated.

Isolation is achieved by the source systems 204A, 204N sharing nothing with the separate workload isolation system 206, and the analytics workload 214 has no impact on the source systems 204A, 204N. However, both the data loading and data refreshing operations are performed by the source systems 204A, 204N, because the separate workload isolation system 206 has read-only access to the databases 208A, 208N of the source systems 204A, 204N when stored into the data hub 210 by the federation 202.

This embodiment also includes an automated isolation advisor described below that assists database administrators 216A, 216N (also labeled as DBA_1 and DBA_N, respectively) for the source systems 204A, 204N in identifying usage patterns and advising on performing the workloads 214 that should run in only in the separate workload isolation system 206, especially the workloads 214 comprising the analytic queries.

Hybrid Isolation Configuration

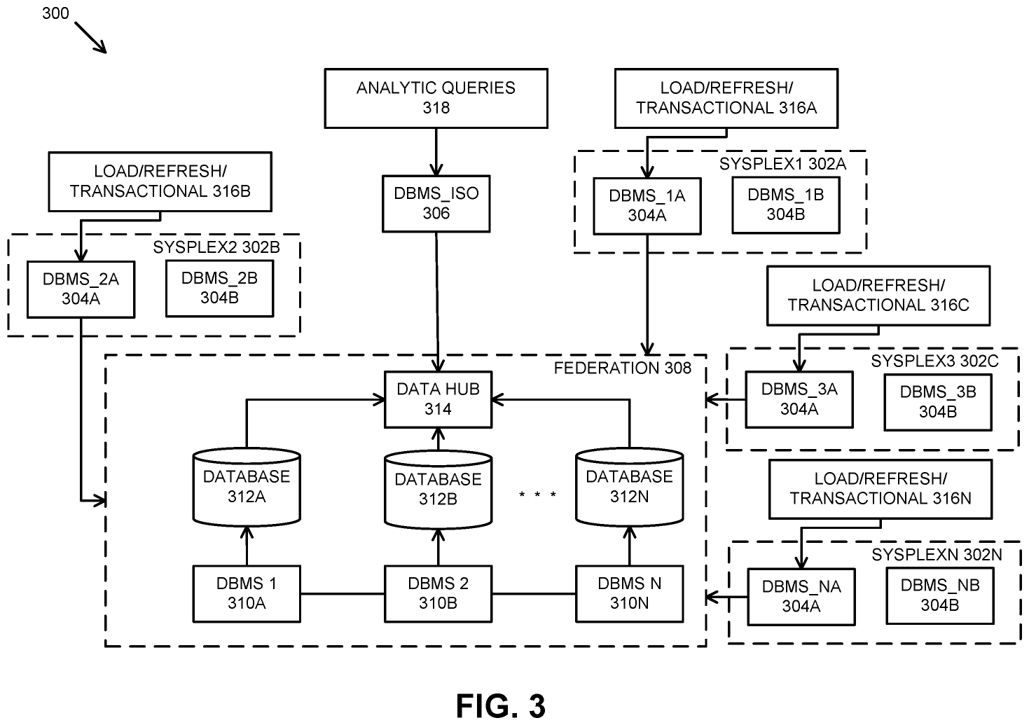

FIG. 3 illustrates a hybrid isolation configuration 300, according to one embodiment. In this embodiment, there are a plurality of system complexes 302A, 302B, 302C, . . . , 302N (also labeled as Sysplex1, Sysplex2, Sysplex3, SysplexN), each of which is a cluster of computer systems acting as a single image, wherein each of the system complexes 302A, 302B, 302C, . . . , 302N is comprised of a plurality of source systems 304A, 304B (also labeled as DBMS_1A, DBMS_1B, DBMS_2A, DBMS_2B, DBMS_3A, DBMS_3B, . . . , DBMS_NA, DBMS_NB, respectively), and a separate workload isolation system 306 (also labeled as DBMS_ISO), as well as a federation 308, which is a distributed system comprised of plurality of source systems 310A, 310B, . . . , 310N (also labeled as DBMS_1, DBMS_2, . . . , DBMS_N, respectively), wherein the source systems 310A, 310B, . . . , 310N, each of which manage one or more databases 312A, 312B, . . . , 312N of a federated database. In addition, a data hub 314 mirroring the databases 312A, 312B, . . . , 312N is provided by the federation 308 for access by the separate workload isolation system 306. The source systems 304A in each of the system complexes 302A, 302B, 302C, . . . , 302N provides operational isolation for processing a workload 316A, 316B, 316C, . . . , 316N, comprised of data loading, data refreshing and/or transactions, while the separate workload isolation system 306 processes a workload 318 comprised of analytic queries, etc., that accesses the data hub 314 provided by the federation 308.

In this embodiment, isolation is provided through a hybrid setting comprised of both a data sharing approach and a federation approach:
Combine the data sharing and federation approaches to take advantage of both approaches in providing better isolation.
Data loading and data refreshing workloads 316A, 316B, 316C, . . . , 316N, are controlled by an isolated data sharing member, namely, source systems 304A.
The workload 318 comprising analytic queries is managed by the separate workload isolation system 306 through the federation 308 (in a manner similar to the federation approach 200 described in FIG. 2).

The hybrid approach 300 provides both workload isolation through the separate workload isolation system 306 and operational isolation through the isolated data sharing source systems 304A.

Basically, the workload 318 comprising analytic queries is directed to the separate workload isolation system 306, while data maintenance is performed by the workloads 316A, 316B, 316C, . . . , 316N comprising data loading and data refreshing operations directed to the isolated data sharing source systems 304A. This hybrid approach 300 combines the benefits of both the data sharing approach 100 of FIG. 1 and the federation approach 200 of FIG. 2. However, it requires additional computer systems, namely, the isolated data sharing source systems 304A and the separate workload isolation system 306.

Automated Isolation Advisor

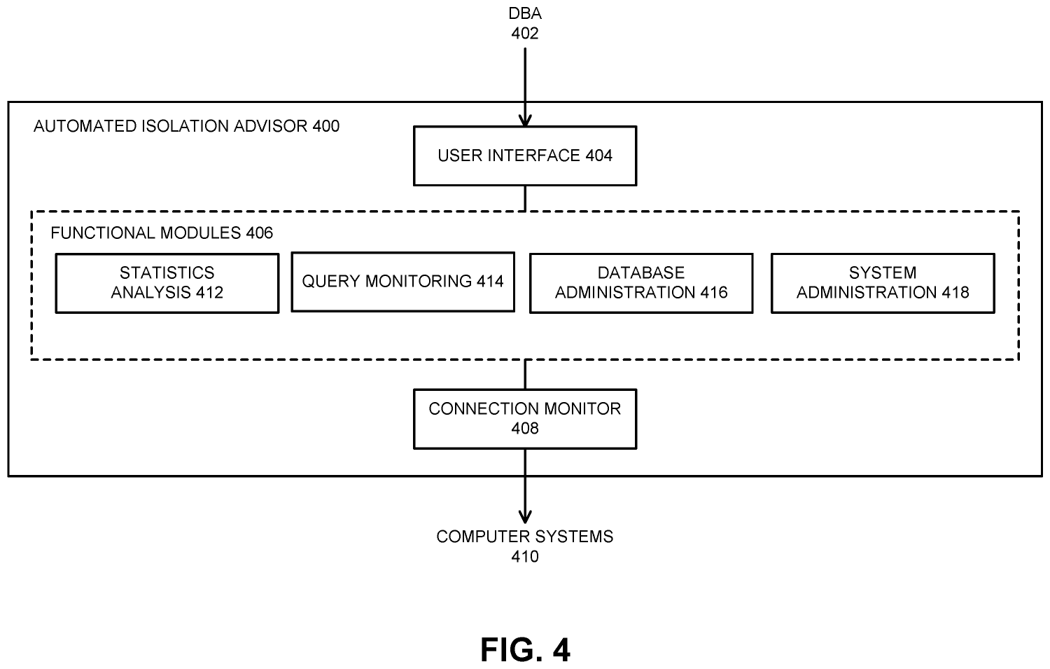

FIG. 4 illustrates an automated isolation advisor 400, according to one embodiment. In this embodiment, the isolation advisor 400 may be performed on any of the computer systems mentioned herein, or on a client computer connected to any of the computer systems mentioned herein. The automated isolation advisor 400 is invoked and accessed by a database administrator (DBA) 402, and includes a user interface 404, functional modules 406, and a connection manager 408 that connects to and configures any of the computer systems 410 mentioned herein. The functional modules 406 include statistics analysis 412, query monitoring 414, database administration 416 and system administration 418.

The automated isolation advisor 400 performs “machine learning” that combines the following factors:
Cost of adding a separate workload isolation system, such as:
   Cost of additional subsystem or additional member; and
   System maintenance overhead of additional subsystems or members.
Reduction in source systems' utilization:
   RLF (Resource Limit Facility) that allows the database administrator 402 to control the amount of resources that are used by SQL statements;
   SMF (System Management Facilities) data analysis, wherein SMF provides full instrumentation of all baseline activities running on a particular computer system, including I/O, network activity, software usage, error conditions, processor utilization, etc.;
   Query monitoring;
   Query costing estimation; and
   Data volume and refresh frequency.

The automated isolation advisor 400 can evaluate and provide advice on:
Isolation options, including an evaluation of the different configurations, including the data sharing isolation configuration, federal isolation configuration, or hybrid isolation configuration;
Which tables to be loaded or federated in the data hubs; and
Which workloads should be re-routed to the separate workload isolation system.

In one embodiment, the automated isolation advisor 400 performs the following functions:
1. Collects and analyzes statistics from the various computer systems;
2. Analyzes workloads to determine which workloads can be performed by the separate workload isolation system, along with frequencies, elapsed times, etc.;
3. Identifies workloads that can be performed by the separate workload isolation system without changes;
4. Identifies workloads that can be performed by the separate workload isolation system with changes;
5. Presents results to the administrator 402, separating the results into different categories: dynamic vs. static, local/batch vs. distributed;
6. Configures and initializes the separate workload isolation system; and
7. Configures and initializes data loading and data refreshing operations in the separate workload isolation system.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

This concludes the description of the various embodiments of the present invention. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Since many embodiments of the invention can be made without departing from the spirit and scope of the invention, the invention resides in the claims hereinafter appended.

What is claimed is:

1. A computer-implemented method, comprising:
providing workload isolation in a hybrid database system, by:
performing a workload in a separate workload isolation system of the hybrid database system, wherein the separate workload isolation system manages data copied from one or more source systems of the hybrid database system and stored on one or more data hubs managed by the separate workload isolation system, and the workload enters the source systems and is re-routed from the source systems to the separate workload isolation system in order to isolate the source systems from the workload being performed by the separate workload isolation system using the data hubs.

2. The method of claim 1, wherein the separate workload isolation system returns result sets from the workload to the source systems.

3. The method of claim 1, wherein the workload comprises one or more queries.

4. The method of claim 1, wherein the workload comprises an initial load of the data from the source systems to the data hubs.

5. The method of claim 1, wherein the workload comprises a refresh of the data from the source systems to the data hubs.

6. The method of claim 1, wherein the hybrid database system comprises a data sharing isolation configuration, wherein a systems complex is comprised of the source systems and the separate workload isolation system, and the source systems and the separate workload isolation system access a shared database.

7. The method of claim 1, wherein the hybrid database system comprises a federal isolation configuration, wherein a federation is comprised of the source systems and the separate workload isolation system, the source systems each manage one or more separate databases of a federated database, and the separate workload isolation system accesses the federated database.

8. The method of claim 1, wherein the hybrid database system comprises a hybrid isolation configuration comprised of both one or more systems complexes and one or more federations, the systems complexes are each comprised of the source systems that access a shared database, the federation is comprised of a federated database from the shared databases of the systems complexes, and the separate workload isolation system accesses the federated database.

9. The method of claim 1, further comprising providing an automated isolation advisor that manages how the source systems interact with the separate workload isolation system.

10. The method of claim 9, wherein the automated isolation advisor creates the separate workload isolation system.

11. The method of claim 9, wherein the automated isolation advisor identifies the workload for re-routing to the separate workload isolation system.

12. The method of claim 9, wherein the automated isolation advisor identifies the data to be stored on the data hubs.

13. A computer-implemented system, comprising:
a hybrid database system for providing workload isolation, by:
performing a workload in a separate workload isolation system of the hybrid database system, wherein the separate workload isolation system manages data copied from one or more source systems of the hybrid database system and stored on one or more data hubs managed by the separate workload isolation system, and the workload enters the source systems and is re-routed from the source systems to the separate workload isolation system in order to isolate the source systems from the workload being performed by the separate workload isolation system using the data hubs.

14. The system of claim 13, wherein the workload comprises one or more queries, an initial load of the data from the source systems to the data hubs, or a refresh of the data from the source systems to the data hubs.

15. The system of claim 13, wherein the hybrid database system comprises a data sharing isolation configuration, wherein a systems complex is comprised of the source systems and the separate workload isolation system, and the source systems and the separate workload isolation system access a shared database.

16. The system of claim 13, wherein the hybrid database system comprises a federal isolation configuration, wherein a federation is comprised of the source systems and the separate workload isolation system, the source systems each manage one or more separate databases of a federated database, and the separate workload isolation system accesses the federated database.

17. The system of claim 13, wherein the hybrid database system comprises a hybrid isolation configuration comprised of both one or more systems complexes and one or more federations, the systems complexes are each comprised of the source systems that access a shared database, the federation is comprised of a federated database from the shared databases of the systems complexes, and the separate workload isolation system accesses the federated database.

18. The system of claim 13, further comprising providing an automated isolation advisor that manages how the source systems interact with the separate workload isolation system, wherein:
the automated isolation advisor creates the separate workload isolation system;
the automated isolation advisor identifies the workload for re-routing to the separate workload isolation system; and
the automated isolation advisor identifies the data to be stored on the data hubs.

19. A computer program product, the computer program product comprising a computer readable storage medium having program instructions embodied therewith, the program instructions executable by one or more computers to cause the computers to perform a method, comprising:
providing workload isolation in a hybrid database system, by:
performing a workload in a separate workload isolation system of the hybrid database system, wherein the separate workload isolation system manages data copied from one or more source systems of the hybrid database system and stored on one or more data hubs managed by the separate workload isolation system, and the workload enters the source systems and is re-routed from the source systems to the separate workload isolation system in order to isolate the source systems from the workload being performed by the separate workload isolation system using the data hubs.

20. The computer program product of claim 19, wherein the hybrid database system comprises:
a data sharing isolation configuration, wherein a systems complex is comprised of the source systems and the separate workload isolation system, and the source systems and the separate workload isolation system access a shared database;
a federal isolation configuration, wherein a federation is comprised of the source systems and the separate workload isolation system, the source systems each manage one or more separate databases of a federated database, and the separate workload isolation system accesses the federated database; or
a hybrid isolation configuration comprised of both one or more systems complexes and one or more federations, the systems complexes are each comprised of the source systems that access a shared database, the federation is comprised of a federated database from the shared databases of the systems complexes, and the separate workload isolation system accesses the federated database.
